(19) United States
(12) Patent Application Publication
(10) Pub. No.: US 2006/0206462 A1
(43) Pub. Date: Sep. 14, 2006

(54) Method and system for document manipulation, analysis and tracking

(75) Inventor: Jimmy N. Barber, Dallas, TX (US)

Correspondence Address: W. THOMAS TIMMONS;THE WHITE HOUSE ON TURTLE CREEK, 2401 TURTLE CREEK BLVD, DALLAS, TX, 75219-4760, US

(73) Assignee: Logic Flows, LLC

(21) Appl. No.: 11/372,842

(22) Filed: Mar. 10, 2006

Related U.S. Application Data
(60) Provisional application No. 60/661,572, filed on Mar. 13, 2005.

(51) Int. Cl. G06F 17/30

(52) U.S. Cl. 707/3

(57) ABSTRACT

A method and system for importing physical documents into one or more electronic documents, searching the electronic documents to automatically code the documents, to collect bibliographic information, to assign the documents to one or more categories, to identify documents with relevance by master keyword searching. This invention also provides the capability of user annotating and/or commenting without disturbing the original content of the documents.

### CROSS-REFERENCE TO RELATED APPLICATIONS

Continuation of Provisional Application No. 60/661,572 filed Mar. 13, 2005

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to methods and systems for the processing and analysis of documents. More specifically, this invention relates to such methods and systems which employs the techniques of scanning the document into an electronic form and than scanning through the electronic document for matching keywords.

2. Description of Related Art

A variety of techniques are used for managing and evaluating documents. Typically, these prior techniques require extensive human intervention to read and categorize the documents. The inventor is unaware of prior method or system which automatically evaluates and categorizes documents based on a comparison with user defined master keywords.

### BRIEF SUMMARY OF THE INVENTION

It is desirable to provide a method and system for locating specific data within electronic documents, storing the found data and associated information into report fields and assigning the documents to desired classifications and to do these functions automatically based on user identified key words.

Therefore, it is an object of one or more embodiments of this invention to provide a method and system for manipulating, analyzing and tracking documents automatically in an electronic form.

It is another object of one or more embodiments of this invention to provide a method and system for manipulating, analyzing and tracking documents that includes scanning the documents into an electronic format.

It is another object of one or more embodiments of this invention to provide a method and system for manipulating, analyzing and tracking documents that includes scanning the electronic document for matching keywords.

It is another object of one or more embodiments of this invention to provide a method and system for manipulating, analyzing and tracking documents that includes assigning the keywords to a report document.

It is another object of one or more embodiments of this invention to provide a method and system for manipulating, analyzing and tracking documents that includes tracking the number of master keywords assigned.

It is another object of one or more embodiments of this invention to provide a method and system for manipulating, analyzing and tracking documents that includes populating a bibliographic database document with information from the scanned electronic document.

It is another object of one or more embodiments of this invention to provide a method and system for manipulating, analyzing and tracking documents that includes category assignment of an electronic database based on the match of category keywords.

It is another object of one or more embodiments of this invention to provide a method and system for manipulating, analyzing and tracking documents that includes an annotator function with a display of the electronic document in a form that allows the addition of comments, lines, highlighting and redacting without modifying the original document.

It is another object of one or more embodiments of this invention to provide a method and system for manipulating, analyzing and tracking documents that is accessible over a computer network.

It is another object of one or more embodiments of this invention to provide a method and system for manipulating, analyzing and tracking documents that provides maximum document processing efficiency with minimal manual interaction.

It is another object of one or more embodiments of this invention to provide a method and system for manipulating, analyzing and tracking documents that includes an automatic coding process.

It is another object of one or more embodiments of this invention to provide a method and system for manipulating, analyzing and tracking documents that is compatible with user customization.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described several preferred embodiments of this invention, simply by way of illustration of modes of the invention suited to carry out this invention. As it will be realized, this invention is capable of other different embodiments, and its several details, steps, and specific features are capable of modification in various aspects without departing from the invention. Accordingly, the objects, drawings and descriptions should be regarded as illustrative in nature and not as restrictive.

### BRIEF DESCRIPTION OF THE SEVERAL VIEWS OF THE DRAWING

The accompanying drawings incorporated in and forming a part of the specification, illustrate one or more preferred embodiments of the present invention. Some although not all, alternative embodiments are also described in the following description. In the drawings:

FIG. 1 is top-level process diagram of the top-level steps of the present embodiment of this invention,

FIG. 2 is a detailed view of the steps of the receive search/category information step of the present embodiment of this invention.

FIG. 3 is a detailed view of the steps of scanning, matching, flagging and populating steps of the present embodiment of this invention.

FIG. 4 is a detailed view of the steps of the category assignment step of the present embodiment of this invention.

FIG. 5 is a detailed view of the steps of the display/annotate step of the present embodiment of this invention.

Reference will now be made in detail to the present preferred embodiment of this invention, an example of which is illustrated in the accompanying drawings.

### DETAILED DESCRIPTION OF THE INVENTION

This invention is a method and system for the importing documents into an electronic format, scanning the electronic documents to match keywords with previously defined master keywords, flagging documents for human review populating a bibliographic database, categorizing the document for type and providing the capability for displaying and annotating the electronic document by users.

In the present preferred embodiment, this invention uses a free form database format, which provides free form database searches by scanning, through an entire or selected parts of an electronic document, typically without any prior manual input of the information from the documents themselves. The user does input Master Keywords and Category Keywords, which along with the category designation associated with the category keywords, are used by the process in the search and categorization of the documents. Once the hard copy of the document at interest is electronically scanned into a computer system operating the process, an optical character recognition (OCR) function is performed converting the scanned document into a searchable and editable electronic document. The process performs a text matching search of the electronic document, comparing each word or word group against the inputted Master Keywords. Each matched Master Keyword is assigned to the electronic document. A test is made to determine if a threshold number of Master Keywords have been assigned to the electronic document. If the threshold is met, a flag or variable is set to indicate that this electronic document should be manually reviewed for content and context. Also, as the electronic document is scanned, bibliographic information is identified and copied into the appropriate bibliographic fields in a bibliographic document attachment. This bibliographic document provides the essentials of the “coding” process common to manual document review. The bibliographic information typically includes such information as: author, date, organization, subject matter, addressee name and company, length of document, type of document (letter, financial report or worksheet, memo, publication, expert or other witness report and the like. During the scan of the electronic document a search is also made for the Category Keywords, the number and identification of the Category Keywords matched is stored. When the Category Keyword scan is completed or the number of Category Keywords exceeds a set threshold, the electronic document is assigned to a particular appropriate category. Typically, the category is identified by the user to permit organization and efficient review of critical documents. The searched electronic document is then presented to users for review. With the aid of the attached bibliographic data, the master Keyword flagging and the Category assignment, the user can then determine which documents are likely to contain the most valuable information for review. The user in reviewing the electronic document is provided with annotation and comment functionality, which permits the user to draw lines, highlight, make redactions and comments on an associated window of the electronic document without the modifying the “original” electronic document. An additional feature included in this annotation feature is an “idea” function, where the person reviewing the document may type in comments in a pop-up box and may read and comment on the comments of other reviewers. In this manner an electronic attachment is provided to the electronic document that permits a “conversation” between reviewers to be made, serially or simultaneously and which still maintains a separation between these comments and the “original” electronic document. This invention, in its present embodiment, is designed to provide high speed searches, information collection, categorization and, in some version, simultaneous review by multiple reviewers through the use of networked computers. Through the use of this invention on computers connected over the Internet, individuals geographically remote from each other can work simultaneously together in the review of documents deemed to be important to an issue, while avoiding the highly time consuming process of reviewing, coding, searching and categorizing the typical majority of documents which are not particularly pertinent to the issue of interest to the user.

In the present embodiment of the invention, the process of this invention is performed with one or more standard desktop or notebook computers connected over a network (intranet or Internet) with an information server. The typical server presently envisioned is a Dedicated Microsoft Windows 2003 server, with Internet Information Server and .NET extensions installed. The server is presently provided with a 3.2 GHz or faster processor, 3.0 Gbytes or greater of Random Access Memory, 5 100 Gbyte Hard Disc Drives and askSam 5 Database Engine, .NET Active Server Programming (ASP.NET), Macromedia Flash application, SHA-512 and Microsoft Internet Explorer Web browser (version 5.5 or later) installed on the server computer. Although this invention may operate on slower computers with less memory, such would slow down the operation of the process. Since the invention can be implemented in a Web based configuration, users can be allowed to import, add, edit, search, annotate and manage the information using Microsoft Internet Explorer Web browser (preferably version 5.5 or later). Security levels are provided in the present embodiment as follows: Administrators who can access all data and system functions and four other levels of user who have varying degrees of restrictions. An import function allows user to import text documents, TIF images, JPG images, PDF images, DVD media and other like files. Full-text and limited field searches of the electronic documents are provided. Presently, the search results return a list of documents which match the search request. A document annotation feature, currently including an “idea” comment box, provides a comment, annotation and redaction of the document under review. Bibliographic documents with the bibliographic fields are populated to provide an overview of document information, make assignments and perform other functions.

The process of this invention can operate on a wide variety of standard computers and can be written in a wide variety of computer languages without departing from the concept of this invention.

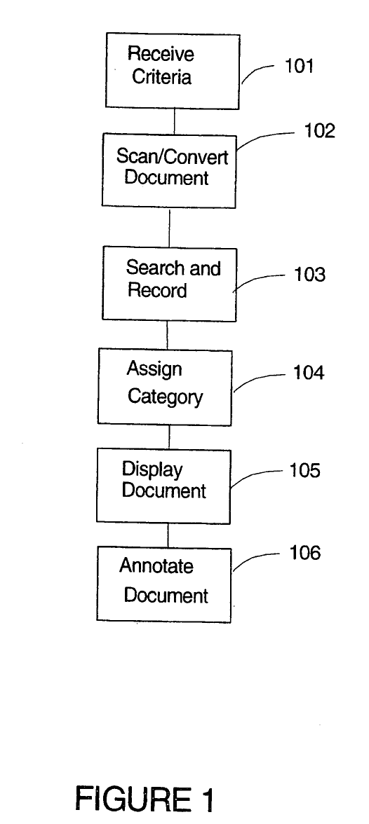

FIG. 1 shows top-level process diagram of the top-level steps of the present embodiment of this invention. Typically in the present embodiment of this invention receives 101 criteria from a user. These criteria will typically include such data as Master Keywords, Category Keywords, names of interest for a search, the Master Keyword threshold and bookkeeping information, such as the user name, project identification, identification of team members, assignment of user-names and passwords, date and the security protocol level. One or more documents are scanned 102 into an electronic format and are then converted from an image to an editable and searchable text file. Presently the scanning is accomplished with a standard high speed digital computer scanner connected to a standard computer or server device and the present conversion is accomplished using standard optical character recognition software running on the standard computer or server device and producing a standard text file (hereinafter referred to as the “electronic document”), formatted to the extent possible to appear similar to the original paper document. The electronic document is then searched 103 with names of interest collected and stored, words matching one or more words in the provided list of Master Keywords collected, stored and counted, works matching one or more words in the provided Category Keywords collected and stored, and bibliographic data is collected and stored in a bibliographic document associated to the electronic document. Typical names would be the names of people, places, organizations and things which the user believes could indicate particular relevance of the document. Typical Master Keywords would be words or word combinations which would indicate relevance, such as dates, items, time periods and the like. Typical Category Keywords would be document descriptions, such as admissions, history, background, opinions, catalogs, financial reports and the like. Typical bibliographic data would be such information as author, date, addressee, subject matter, document type (memo, opinion, deposition, interrogatory, interview, summary, letter, publication) and the like. Using the matches with the Category Keywords, a category is assigned 104 to the document. The searched electronic document is then displayed 105 to the user. Annotating 106 the electronic document with comments from the user, such comments typically stored in one or more comment documents associated with the electronic document and where typically the comment documents can be opened and displayed to the user(s) through pop-up boxes or through a side-by-side placement with the electronic document. Preferably the comment document is created, edited and maintained without affecting the content of the electronic document, although the comment document may be present in a manner in which it overlays the electronic document to more easily permit the user to correlate the user(s) comments to the specific parts of the electronic document.

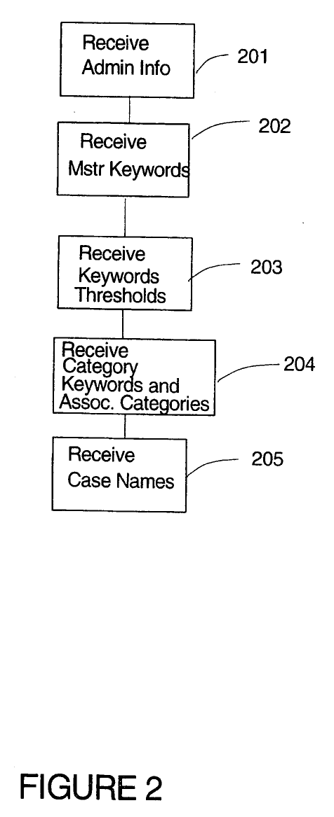

FIG. 2 shows a detailed view of the steps of the receive search/category information step of the present embodiment of this invention. Administrative information is received 201. This administrative information will typically include an initial file set-up with user names and passwords. A list of one or more master keywords is received 202. These master keywords are used to determine the relevance of the document being scanned. A master keyword threshold is received 203. This threshold is used to establish the level at which the document is determined to be relevant because of the number and/or context of the master keywords identified during the scan. Category keywords, along with the categories associated with the category keywords, are received 204. The category keywords are used to assign the document to one or more categories. Case names are received 205 to identify the names of interest in the case. Although these steps are shown in an ordered flow, these steps are largely and essentially independent of each other and can be reordered in their performance without departing from the concept of this invention.

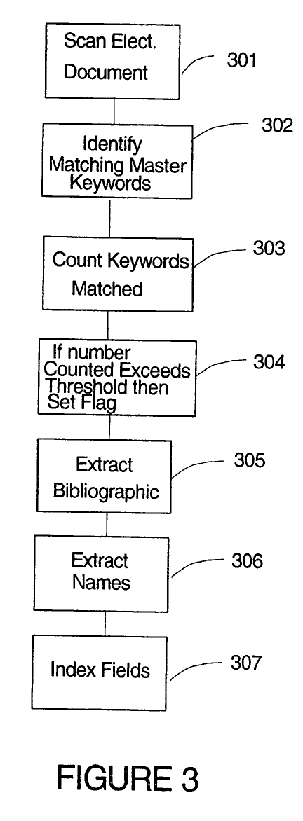

FIG. 3 shows a detailed view of the steps of scanning, matching, flagging and populating steps of the present embodiment of this invention. After the document has been electronically scanned and converted to a searchable text format, typically using standard OCR processing, the electronic text document is scanned 301, typically line by line and word by word. As the document is scanned words are compared with the list of master keywords to identify 202 any and all master keywords which are matched in the text document. Each matched master keyword is counted 303. If the number of counted matched master keywords exceeds the set threshold, then a flag is set 304. By flag the applicant means a variable, device or indicator set to a particular value to indicate the state of a condition in the process. The flag may be but is not necessarily a single bit or number and can be any value which the process can either display or test against. In this instance, the flag when set indicates that the document is deemed by the process to be sufficiently relevant to be individually reviewed. The bibliographic information is extracted 305 or copied into a bibliographic document. Names are also extracted 306 or copied, typically by matching the names in the document to the list of names previously received. The process also indexes 307 the fields filled by the extracted or copied information for use in future efficient searches.

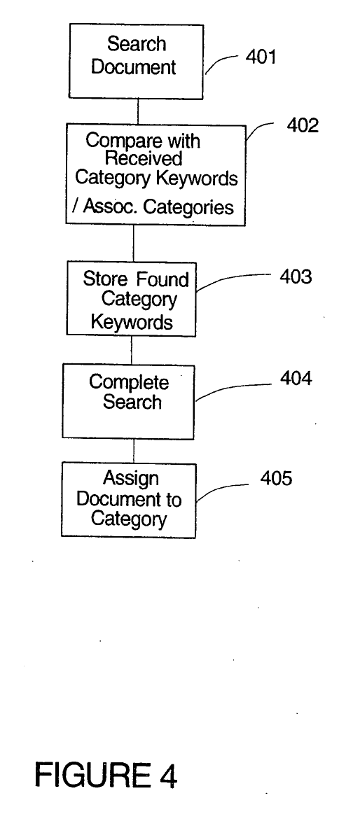

FIG. 4 shows a detailed view of the steps of the category assignment step of the present embodiment of this invention. The searchable electronic document is searched 401, comparing 402 words found within the document with received category keywords and the one or more categories associated with the category keywords. When a category keyword is found within the document it is stored 403. The search is completed 404 and the document is assigned 405 to one or more categories based on the category keywords found.

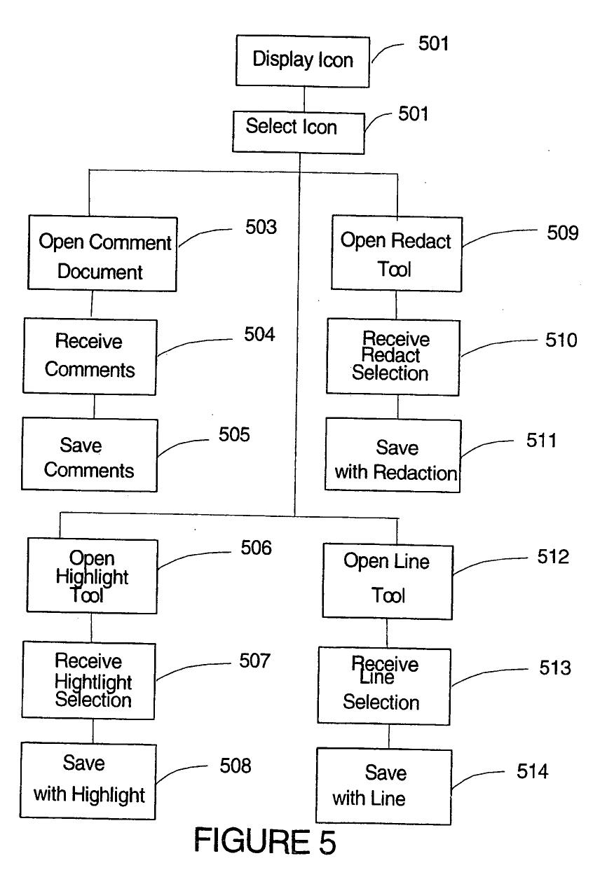

FIG. 5 shows a detailed view of the steps of the display/annotate step of the present embodiment of this invention. This display annotation feature is provided to allow the user to make comments, highlight, redact and to draw reference lines in relation to an electronic document. One or more icons are displayed 501. The desired function is selected by selecting 501 the appropriate icon. If the comment icon is selected, a comment document is opened 503. The present comment document is a box overlaying and linked to the electronic document in which the user may insert comments. The user's comments are received 504 and then the comments are saved 505 for viewing by authorized users. If the highlight icon is selected, the highlight tool is opened 506. The present highlight tool is a yellow box which can be placed over a section of the document to draw attention to the selected text. The highlight selection is received 507 and is saved 508 for future viewing. If the redact icon is selected, the redact tool is opened 509. The present redact tool is a black box which can be placed over a section of the document to block that section of the document from view. The redact selection is received 510 and is saved to block the selected text from further view. If the line icon is received, the line tool is opened 512. A line element is then positionable by the user on the electronic document. The line selection is received 513 and is saved 514 for future viewing by a user.

The present implementation of the invention uses the following file and data field structures. With regard to data structures, the following is a description of the directory tree, the document images, the document (OCR) texts, and the databases. The directory tree is presently rooted at \Inetpub\wwwroot\ and the application directory is at \Intepub\wwwroot\asDocumentServer, from where the web application pages are accessible. The application directory further includes an image directory for web page layout; a site database for user information and case information and a data subdirectory. The present data subdirectory has its own case subdirectory designated by the case number, each case subdirectory having a case image directory and a case.ask file for the data of the case. The document images are the original scanned documents of the end user, typically and presently in TIFF format they are stored in the case image directory. Security for the document images is provided presently by using the Macromedia Flash view which can hide the name of the file from using “View Source”. It is also possible to configure IIS and use ASP.NET's http handler to prevent access to files unless the user (or group) has given access permission. Document (OCR) texts are presently simple ASCII text files, typically they are not stored on the server but are uploaded by the administrators using the Import Module. The databases within the data structures include an application database for each application. The application database includes the following user information for the application: USER_id (nine digits zero left padded issued sequentially for each user); Username; Password, Last Name; First Name; Email address; User Level; Cases; Global User Level and Rights. The current user levels are: Admin, granting access to all cases, all rights and has import permission; Level 4, granting rights to annotate, update meta tags, copy, search, print, export and save documents; Level 3, granting rights to annotate, copy search, print, export and save documents but not update meta tags; Level 2, granting rights to copy, search, print, export and save documents, but not to make annotations, view annotations, or update meta tags; and Level 1, granting rights to read only, not allowed to print, copy, save, export, make or view annotations or update meta tags. The case information of the database includes: User_Case_id. User_id. Case_id, Permissions (Read/Edit/Annotate). The Global User Level is provided to give a default set of permissions for all documents. Rights can be attached to search results as well, with a set of results fully processed but then masked according to the user's permissions.

With regard to the case information, the following is a description of the case identifiers, case databases, annotations and database security. The current case identifiers include the Case_id, a sequentially assigned left zero-padded nine digits, Case_number, the number associated with the case and Case_name, a readable name for the case. The case databases are presently provided one for each case. Documents can be added in the case database and field information edited depending on the user's authorizations/permissions. In the present version, documents cannot be deleted from the case database, although this function may be added in later versions. The case database includes ASCII text from the OCR of the document images. It also includes the following automatic fields associated with the document: Document_id, a left zero padded number of the form ddddddddd (e.g. 000000012), future versions of the Document_id may recognize alpha numeric characters; Begin Document Number; End Document Number, Author, Recipient, cc's, Title, Category, Keywords, Names in Text, Date_created, Created_by (the user identification of the administrator who imported the document to the case database), Filename (the original name of the OCR generated text file), META fields (which can be populated automatically at time of import). The case database also presently includes the following META fields: Keywords, Author, Recipient, cc's, Title, Date, Content (description of the document), Beginning Document Number, Ending Document Number, Category, Document Type, Names in Text. These META fields are intended to be searchable, although presently the administrator or a user with level 4 authority would be required to enter and or edit any of these twelve fields. The case information also includes annotation information, which will typically be one annotation document for each case and will include the following fields: Annotation_id, Case_id, Document_id, User_id, Date Time, Comment and Coordinates; and support for the following features: highlighter, redactor and line draw. Annotations will generally be searchable. The case information database security is provided presently by requiring askSam to use database encryption with passwords and in some cases to mask access to particular askSam databases.

With regard to the user system, the following is a description capabilities provided to the administrators, coders/paralegals, attorneys and the user information. Administrators are given authority to import text documents using the Import Module, to import images into a case directory using the Import Module, to add or delete cases, to add, edit or delete users, to search, retrieve and annotate document images and to add META data to documents. Coders and paralegals have authority to search, retrieve and annotate document images, to add information to the META field, and in a future embodiment to change their passwords. Attorneys have authority to search, retrieve and annotate document images and in a future embodiment to change their passwords. Users have a user name for log in purposes, will typically use their first and last name, the case number and password assigned by the administrator.

With regard to the search system, the following is a description of the query request and the document page. Searching can be done with a query request or through the document page. The query request can be a “simple” search that uses a straight forward search of the imported text with the user's restrictions acting as filter or an “advanced” search, which uses Keywords from the keywords field entered by the administrator, annotations, user entered field restrictions and/or free text from the OCR of the image file. The result of the query search is aggregated for the user. The document page search presently uses the Macromedia Flash application program working in conjunction with an ASP.NET backend. This displays a representation (an image approximating the original) of the original document image in the flash application. The document page search has the following capabilities: the user can select a section of the document for comment reference, presently a rectangular comment area is provided; the user can add or edit a comment, with the added or edited comment recorded in the annotation database. The document page search provides the user a highlight capability to highlight text on the viewed image, a redact capability to remove text from the viewed image and a line draw capability to allow the user to draw a line on the viewed image.

With regard to the import system, the following is a description of the import capabilities. The import system is capable of importing ASCII text files associated with TIF images, Microsoft Word, PowerPoint, Excel and other like files, converted to text format for searching purposes with the converted documents stored on computer hard disk for view purposes. The import system can also import and store to disk binary files (including MPEG, AVI files and the like. Presently these files are only searchable to the extent there are predefined fields or OCR text located within the binary file. The ASP.NET page allows the user to upload an image and its corresponding text. Also, CSV files of META data can be imported using a bulk import application as can OCR text files with associated image files. Future envisioned enhancements to the import process will allow more that one file to be uploaded at a time.

With regard to the security system, the following describes its capabilities. The present security system uses ASP.NET forms authentication. Access to all pages except the log in page is blocked unless the user is logged in. Access level information is used to determine if a user is permitted to view a page. The present log in page contains prompts for the case sensitive username, password and case number.

As noted above, this invention is designed so that it can be written in a wide range of well known computer languages and to be integrated into standard database software products. The present implementation uses the askSam SDK database engine through a SDK Single Server License and SDK 5 User Network using Macromedia flash software for the implementation of the annotator section of the invention.

It is to be understood that the above described embodiments and examples are merely illustrative of numerous and varied other embodiments and applications which may constitute applications of the principles of the invention. These example embodiments are not intended to be exhaustive or to limit the invention to the precise form, connection or choice of components, computer language or modules disclosed herein as the present preferred embodiments. Obvious modifications or variations are possible and foreseeable in light of the above teachings. These embodiments of the invention were chosen and described to provide the best illustration of the principles of the invention and its practical application to thereby enable one of ordinary skill in the art to make and use the invention, without undue experimentation. Other embodiments may be readily devised by those skilled in the art without departing from the spirit or scope of this invention and it is our intent that they be deemed to be within the scope of this inventions as determined by the appended claims when they are interpreted in accordance with the breadth to which they are fairly, legally and equitably entitled.

I claim:

1. A method for document analysis, comprising:
(A) receiving master keywords;
(B) receiving an electronically scanned document;
(C) converting said electronic scanned document to a searchable and editable document:
(D) searching said searchable and editable document for words which match said master keywords;
(E) assigning said matched master keywords to said searchable and editable document;
(F) determining if a threshold number of matched keywords is exceeded; and
(G) setting a flag if said threshold number of matched keywords is exceeded.

2. A method for document analysis, comprising:
(A) receiving category keywords and categories associated with said category keywords;
(B) receiving an electronically scanned document;
(C) converting said electronic scanned document to a searchable and editable document:
(D) searching said searchable and editable document for words which match said category keywords; and
(E) assigning said searchable and editable document to a category based on said match of category keywords.

3. A method for document analysis, comprising:
(A) receiving an electronically scanned document;
(B) converting said electronic scanned document to a searchable and editable document:
(C) searching said searchable and editable document for bibliographic text;
(D) saving said bibliographic text to a bibliographic document associated with said searchable and editable document to effect coding of said document.

4. A method for document analysis, comprising:
(A) receiving an electronically scanned document;
(B) converting said electronic scanned document to a searchable and editable document:
(C) opening an associated document for storing comments with regard to said searchable and editable document;
(D) receiving comments with regard to said searchable and editable document;
(E) storing said comments on said associated document, and
wherein said comment further comprises a text comment, a highlighting, a redaction and a line insertion.

5. A method for document analysis, comprising:
(A) receiving an electronically scanned document;
(B) converting said electronic scanned document to a searchable and editable document:
(C) searching said searchable and editable document for names; and
(E) storing said names in a document associated with said searchable and editable document.

6. A method for document analysis, comprising:
(A) receiving master keywords and category keywords;
(B) receiving an electronically scanned document;
(C) converting said electronic scanned document to a searchable and editable document:
(D) searching said searchable and editable document for words which match said master keywords;
(E) assigning said matched master keywords to said searchable and editable document:
(F) determining if a threshold number of matched keywords is exceeded;
(G) setting a flag if said threshold number of matched keywords is exceeded;
(H) searching said searchable and editable document for words which match said category keywords;
(I) assigning said searchable and editable document to a category based on said match of category keywords;
(J) searching said searchable and editable document for bibliographic text;
(K) saving said bibliographic text to a bibliographic document associated with said searchable and editable document to effect coding of said document;
(L) opening an associated document for storing comments with regard to said searchable and editable document;
(M) receiving comments with regard to said searchable and editable document wherein said received comments further comprises a text comment, a highlighting, a redaction and a line drawing;
(N) storing said comments on said associated document;
(O) searching said searchable and editable document for names; and
(P) storing said names in a document associated with said searchable and editable document.
